(19) United States
(12) Patent Application Publication
(10) Pub. No.: US 2005/0111947 A1
(43) Pub. Date: May 26, 2005

(54) Universal pickup loading ramp

(76) Inventors: Joseph Alfred Webb, Buford, GA (US); Douglas Chandler Hoyt, Malabar, FL (US)

Correspondence Address: Douglas Chandler Hoyt, 2250 Duncil Lane, Malabar, FL, 32950, US

(21) Appl. No.: 10/720,461

(22) Filed: Nov. 24, 2003

(51) Int. Cl. B60P 1/00

(52) U.S. Cl. 414/537

(57) ABSTRACT

A loading ramp and replacement tailgate mechanism provided for installation and use in pickup trucks and like vehicles to facilitate the loading of motorcycles. The assembly would replace the existing tailgate, extending the bed and using the same hardware as the tailgate. The ramp consists of two telescoping sections and provides for self contained storage of the ramp when installed. The ramp pivots on the new tailgate structure as the load moves upwards on the ramp and eliminates the change in angle as it occurs at the juncture of the inclined portion of the ramp and the truck bed. The device provides for load sharing between the truck bed and sides. The device allows for installation and removal from the truck by one person without the use of tools.

### REFERENCES CITED

### U.S. PATENT DOCUMENTS

U.S. Pat. No. 460,196 September 1891 Chase . . . n/a

U.S. Pat. No. 3,352,440 November 1967 Wilson . . . . 214/85

U.S. Pat. No. 4,990,049 February 1991 Hargrove . . . 414/537

U.S. Pat. No. 5,273,335 December 1993 Belknap et al . . . 296/61

U.S. Pat. No. 5,312,149 May 1994 Boone . . . 296/61

U.S. Pat. No. 5,540,474 July 1996 Holland . . . 296/61

U.S. Pat. No. 5,907,276 May 1999 Lance . . . 340/425.5

U.S. Pat. No. 6,076,215 June 2000 Blankenship et al . . . 14/71.1

U.S. Pat. No. 6,296,290 October 2001 Wolf . . . 296/61

### BACKGROUND

The present invention relates to mounting, installing, attaching a loading ramp to a pickup truck or related vehicle. A common loading ramp for a pickup truck is the use of a wooden, metal or other material ramp with one end on the ground and the other propped or attached to the end of the tailgate or truck bed. This method has sustained improvements through the addition of clamps, straps or brackets to prevent slippage of the ramp. These prior methods do not address the change in angle at the juncture of the incline ramp and the horizontal truck bed. Moreover, the prior ramp devices have a number of drawbacks including excessive weight and size to achieve load strength, no provision of storage on the truck after loading, complicated design and installation/assembly process and insufficient strength for heavy loading.

### SUMMARY OF THE INVENTION

An object of the present invention is to provide a method of loading a pickup truck that is universal, economical, mechanically simple to install and operate and has the necessary structural strength to sustain the loading of motorcycles, ATV's and other similar devices in the bed of a pickup truck. Storage of this device when not installed on the pickup truck is a simple matter of hanging on a convenient wall space.

Another object of the invention is to eliminate the sharp change in angle at the point of juncture between the ramp and the bed of the pickup truck which contributes to high centering during the loading of long wheelbase motorcycles or similar devices.

A further object is to allow the installation and removal of the loading ramp assembly by one person without the use of tools.

The above objects in connection the elimination of the requirement of a trailer to transport motorcycles, ATV's and the provision to transport safely within a pickup truck becomes apparent upon reference to drawings and numerals contained herein.

### BRIEF DESCRIPTION OF THE DRAWINGS

The summary and other objects, advantages and features of the invention will become apparent from consideration and review of the claims and the description of the drawings in which:

FIG. 1 depicts a fragmented perspective view of a pickup truck with the tailgate and ramp assembly installed in the retracted position and constructed in accordance with the principles of the subject invention.

FIG. 2. depicts a perspective view of the ramps proper in the retracted position.

FIG. 3. depicts a perspective view of the ramps proper in the extended position.

FIG. 4. depicts a perspective view of the connector lug between the ramp proper and the damping linkage.

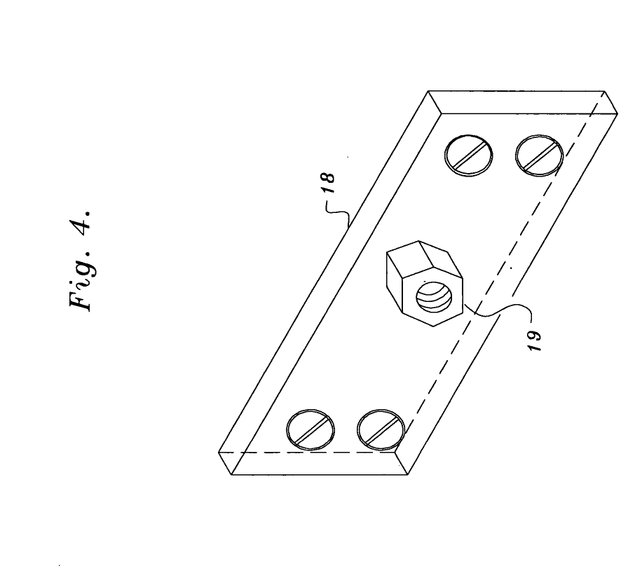

FIG. 5. depicts a fragmented elevation view of the ramp support frame and damping linkage.

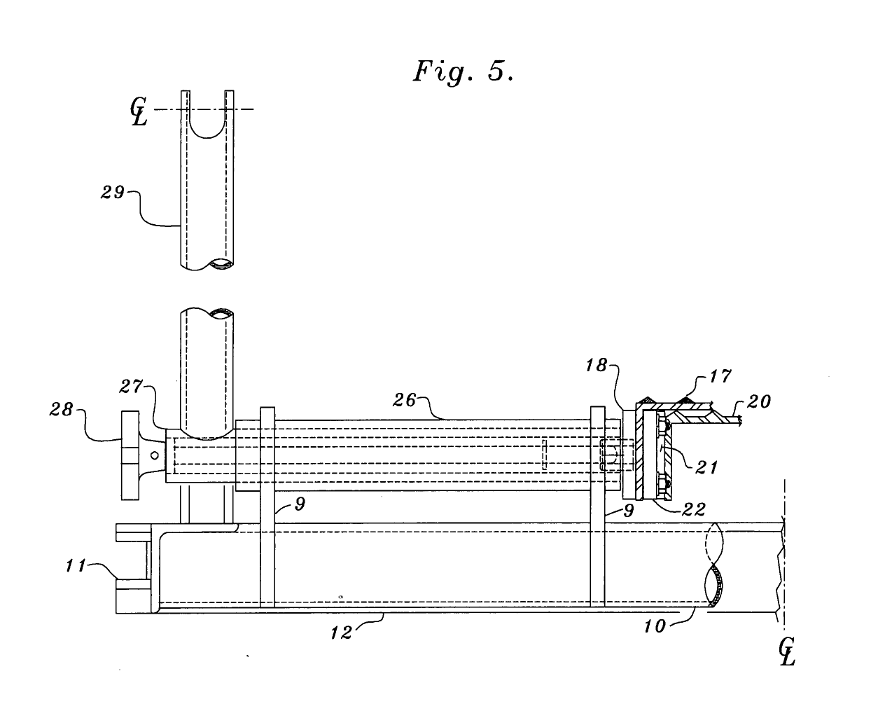

FIG. 6. depicts a plan, end and front and rear elevation views of the tailgate replacement/ramp support frame.

FIG. 7. depicts a perspective view of the ramp support attachment/adaptor plate.

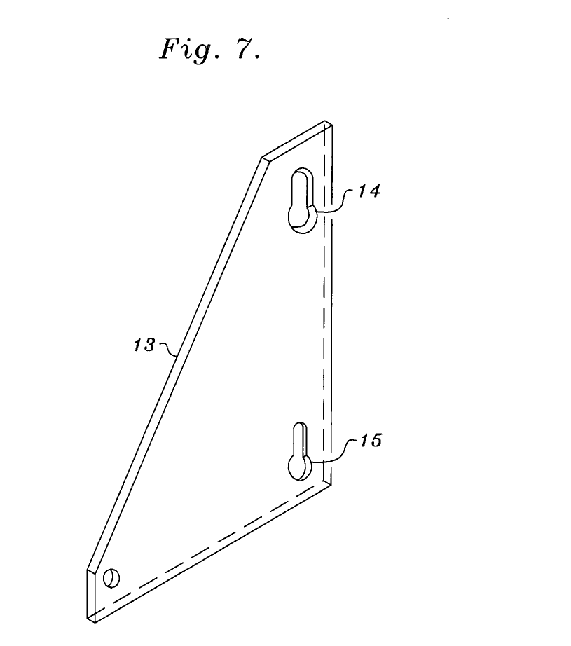

FIG. 8. depicts a perspective view of link between the ramp support attachment plate and the ramp support proper.

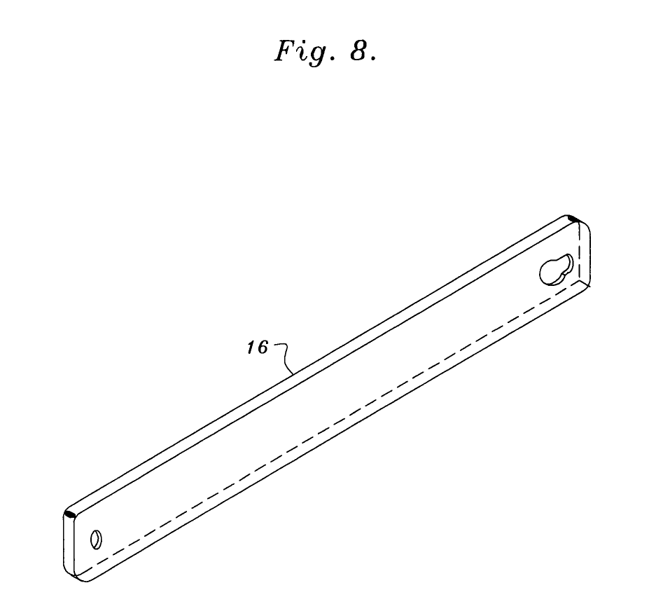

### DETAILED DESCRIPTION OF THE DRAWINGS

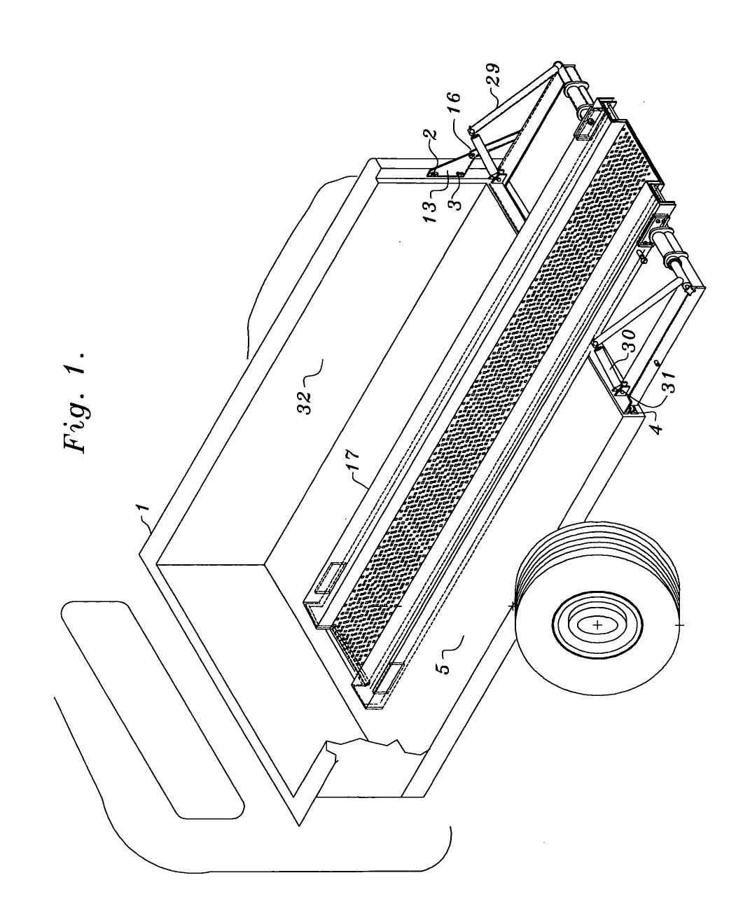

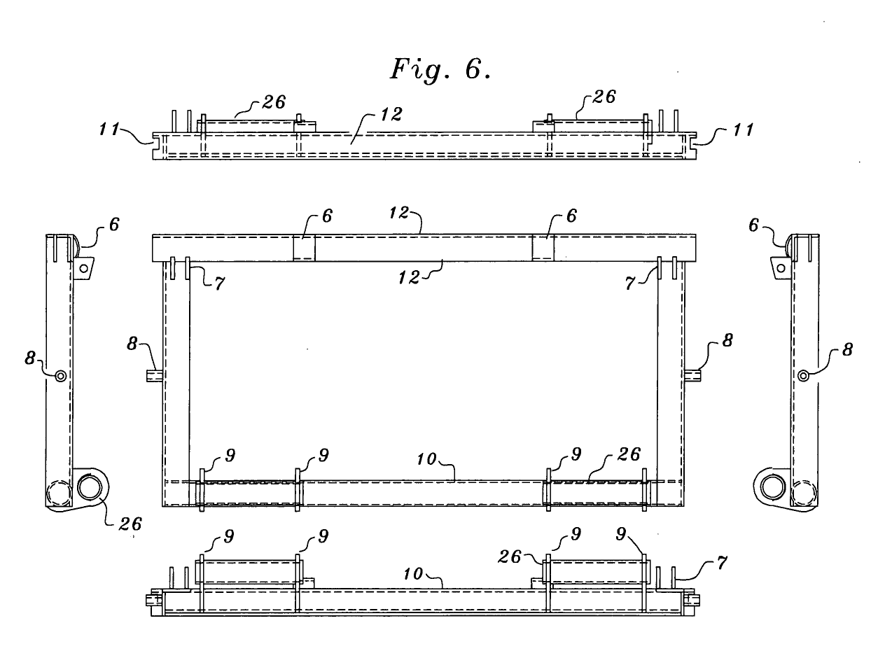

FIG. 1 shows a ramp/ramp support frame at the rear open end of a pickup truck. The pickup truck (1) is a perspective-fragmented view including vertical sidewalls (32) and a bottom bed of the truck (5), the ramp (17 & 18) and ramp support frame (FIG. 6.). The ramp support frame (FIG. 6.) installs using the same lug pivot points and mounting points as a conventional tailgate. The support frame mounting slots (11) are designed to allow the frame assembly (FIG. 6.) to move forward as load is applied, thus transferring load from the frame (FIG. 6.) to the truck bed (5) along support frame member (12). The ramp support frame (FIG. 6.) is further supported and load transferred to the vertical sidewalls of the pickup truck (32) through a connection plate (13) and connection strap (16). The connection plate (13) has keyhole type slots (14 & 15) to allow assembly, without the use of tools, to the pickup bed vertical walls and hardware (2 & 3) as furnished by the pickup truck manufacturer.

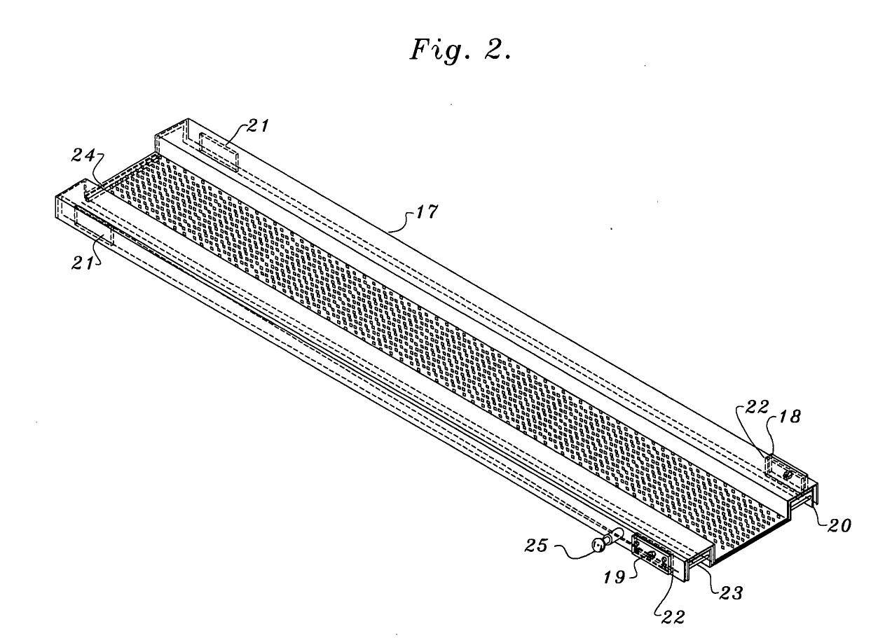

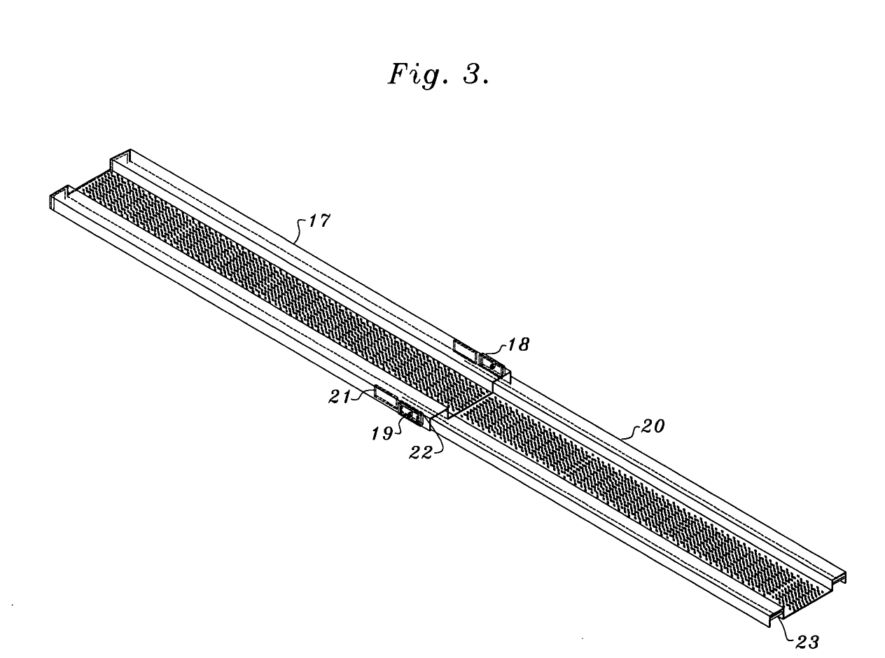

The ramp as shown in FIGS. 2 & 3, is comprised of two channel sections (17 & 20) constructed to allow the outer ramp section (17) to be fixed to the ramp support frame (FIG. 6.) and the inner ramp section (20) to extend rearward from the truck bed, as shown in FIG. 3. The inner ramp in the extended position becomes fixed as it cams over (10) and remains in the extended fixed position until lifted up to be retracted into the outer ramp (17). Once in the retracted position it is held in place by a spring-loaded latch (25). The internal or sliding portion of the ramp assembly (20) is fitted with handles (23) on both sides of the ramp to facilitate the extension and retraction process. Moreover, these handles are of such a size to counterweight the sliding portion of the ramp (20) to facilitate balance of the device. The outer ramp (17) and the inner ramp (20) are fitted with stops (21 & 22) to prevent the overextension of the inner ramp (20) when sliding it to the fully extended position (FIG. 3.). The inner ramp (20) is held in the extended position in relationship to the outer ramp (17) by cam action over the bar (10) of the support frame (FIG. 6.). The ramp at this point is effectively is a continuous surface which can tilt about the pivot point support (9) mounted on the ramp support frame (FIG. 6.). The ramp is affixed to the pivot bar (27) by means of a plate (18) and a hex key (19) and is held in place by threaded bar and knob assembly (28). The pivot bar (27) is connected to a lever arm (29) which connects to a damper assembly (30) which connects between the lever arm (29) and the opposite end mounting and reaction point (7). By so doing, this allows the ramp to move between a horizontal position parallel with the truck bed (5) and a diagonal position between the truck bed and the ground, thus providing a smooth incline between the ground and the truck bed. As the load moves upward on the ramp assembly, the ramp moves from an inclined position to a horizontal position again parallel with the truck bed. The damper (30) and lever arm/pivot assembly (27 & 28) cause the ramp to move through the arc in a smooth controlled manner consistent with upward moving load. Once the load has moved fully upward on the ramp assembly (20 & 17), the load would now be in a horizontal attitude in and parallel with the truck bed (5). The inner ramp (20) can be lifted by hand and returned to the retracted stowed position inside the outer ramp (17). Utilization of the ramp to unload the truck is the reverse of the above process.

1. A loading device for a pickup truck having a bed with tailgate mounting brackets, the loading device comprising of:
a ramp support frame connecting to the tailgate support brackets;
a adaptor plate and arm connecting the pickup tailgate closing studs to the ramp support frame;
a two section pivoting telescoping ramp assembly with mounting lugs which attach to the ramp support frame, ramp assembly when extended to provide an inclined surface to the truck bed;
a arm connecting ramp assembly mounting lugs to a pneumatic or hydraulic damper to modulate the rate of pivot of the ramp;
a damper to modulate the rate of pivot.

2. A loading device of claim 1 wherein the ramp support frame uses the tailgate mounting brackets for attachment.

3. A loading device of claim 2 wherein the loading ramp consists of two telescoping sections pivotally coupled to the ramp support frame.

4. A loading device of claim 3 wherein the loading ramp may be secured in the closed position

5. A loading device of claim 4 wherein the loading ramp may be easily removed from the ramp support frame.

6. A loading device of claim 5 wherein the loading ramp pivotal movement is controlled by the use of damping device.

7. A loading device of claim 6 wherein the entire device may be installed or removed by one person without the use of tools.

8. A loading device of claim 7 wherein the ramp raises and lowers about a central pivot point located on the ramp support frame.

9. A loading device of claim 8 wherein the loading ramp and support frame extends the bed of the truck, thus allowing for additional cargo space.

10. A loading device of claim 9 wherein the loading ramp, support frame and mounting components may be dimensionally adjusted to be utilized with various trucks and related vehicles.
